(19) United States
(12) Patent Application Publication
(10) Pub. No.: US 2023/0204205 A1
(43) Pub. Date: Jun. 29, 2023

(54) ABNORMALITY DETECTION DEVICE AND ABNORMALITY DETECTION METHOD

(71) Applicant: IHI Corporation, Tokyo (JP)

(72) Inventors: Hiroki SAITO, Tokyo (JP); Hirotaka KAWABE, Tokyo (JP)

(73) Assignee: IHI Corporation, Tokyo (JP)

(21) Appl. No.: 18/171,847

(22) Filed: Feb. 21, 2023

Related U.S. Application Data
(63) Continuation of application No. PCT/JP2021/031930, filed on Aug. 31, 2021.

(30) Foreign Application Priority Data
Nov. 30, 2020 (JP) 2020-197857

(51) Int. Cl. F22B 35/18

(52) U.S. Cl. CPC F22B 35/18

(57) ABSTRACT

Provided is an abnormality detection device, including: a data acquisition unit configured to acquire operation data of one or a plurality of extraction devices configured to extract water from a water circulation system in a boiler to an outside of the circulation system, and acquire an actually measured value of a makeup water amount supplied to the circulation system; a prediction unit configured to derive a predicted value of the makeup water amount based on the operation data acquired by the data acquisition unit; and a comparison unit configured to compare the actually measured value of the makeup water amount, which is acquired by the data acquisition unit, and the predicted value of the makeup water amount, which is derived by the prediction unit, with each other.

### CROSS REFERENCE TO RELATED APPLICATIONS

This application is a continuation application of International Application No. PCT/JP2021/031930, filed on Aug. 31, 2021, which claims priority to Japanese Patent Application No. 2020-197857 filed on Nov. 30, 2020, the entire contents of which are incorporated by reference herein.

### BACKGROUND ART

### Technical Field

The present disclosure relates to an abnormality detection device and an abnormality detection method.

A boiler heats supplied water with a high-temperature combustion exhaust gas, which is generated by combustion of fuel such as coal, in a plurality of heat exchangers to thereby generate steam. The combustion exhaust gas contains a highly corrosive component generated from a sulfur component in the fuel. Further, after the boiler undergoes repeated activation, stop, and change in load, cyclic fatigue occurs in, for example, a heat transfer tube of the heat exchanger or a connection pipe that connects the heat exchangers to each other. Thus, the heat transfer tube, the connection pipe, or other parts may break in some cases. In those cases, the steam may leak from the heat transfer tube, the connection pipe, or other parts to an outside.

As a technology of detecting a steam leak, there is described a technology of observing whether or not each of a plurality of phenomena that occur at the time of a leak (tube leak) from the pipe of the boiler has exceeded its preset boundary value. Then, a position in the boiler at which occurrence of a tube leak has been identified is displayed, and a warning is issued (for example, Patent Literature 1).

### CITATION LIST

### Patent Literature

Patent Literature 1: JP 4963907 A

### SUMMARY

### Technical Problem

However, the phenomena that occur at the time of a tube leak, which are described in Patent Literature 1, include phenomena that occur due to factors other than a tube leak. Thus, the technology described in Patent Literature 1 has a problem in that the occurrence of a tube leak may be erroneously determined.

In view of the problem described above, the present disclosure has an object to provide an abnormality detection device and an abnormality detection method that accurately detect a steam leak in a boiler.

### Solution to Problem

In order to solve the above-mentioned problem, according to one aspect of the present disclosure, there is provided an abnormality detection device, including: a data acquisition unit configured to acquire operation data of one or a plurality of extraction devices configured to extract water from a water circulation system in a boiler to an outside of the circulation system, and acquire an actually measured value of a makeup water amount supplied to the circulation system; a prediction unit configured to derive a predicted value of the makeup water amount based on the operation data acquired by the data acquisition unit; and a comparison unit configured to compare the actually measured value of the makeup water amount, which is acquired by the data acquisition unit, and the predicted value of the makeup water amount, which is derived by the prediction unit, with each other.

Further, the prediction unit may be configured to derive the predicted value of the makeup water amount by performing predetermined statistical processing on the operation data.

In addition, the statistical processing may be processing of deriving an integrated value, an average value, or a variance of the operation data of the extraction device in a predetermined period.

Still further, at least one of the plurality of pieces of operation data used in the prediction unit may be acquired at a timing or in a period different from a timing or a period at or in which the other piece of operation data is acquired.

In order to solve the above-mentioned problem, according to the one aspect of the present disclosure, there is provided an abnormality detection method, including: a step of acquiring operation data of one or a plurality of extraction devices configured to extract water from a water circulation system in a boiler to an outside of the circulation system, and acquiring an actually measured value of a makeup water amount supplied to the circulation system; a step of deriving a predicted value of the makeup water amount based on a plurality of acquired pieces of the operation data; and a step of comparing the acquired actually measured value of the makeup water amount and the derived predicted value of the makeup water amount with each other.

### Advantageous Effects of Disclosure

According to the present disclosure, a steam leak in the boiler can be accurately detected.

### BRIEF DESCRIPTION OF DRAWINGS

FIG. 1 is a diagram for illustrating a boiler system according to an embodiment.

FIG. 2 is a diagram for illustrating an abnormality detection device.

FIG. 3 is a diagram for illustrating construction of a prediction unit.

FIG. 4 is a flowchart for illustrating a flow of processing of an abnormality detection method according to the embodiment.

FIG. 5 is a graph for showing a time-dependent change in difference between an actually measured value and a predicted value, which are derived by the abnormality detection device.

### DESCRIPTION OF EMBODIMENT

Now, with reference to the attached drawings, one embodiment of the present disclosure is described in detail. The dimensions, materials, and other specific numerical values represented in the embodiment are merely examples used for facilitating the understanding of the disclosure, and do not limit the present disclosure otherwise particularly noted. Elements having substantially the same functions and configurations herein and in the drawings are denoted by the same reference symbols to omit redundant description thereof. Further, illustration of elements with no direct relationship to the present disclosure is omitted.

### Boiler System 100

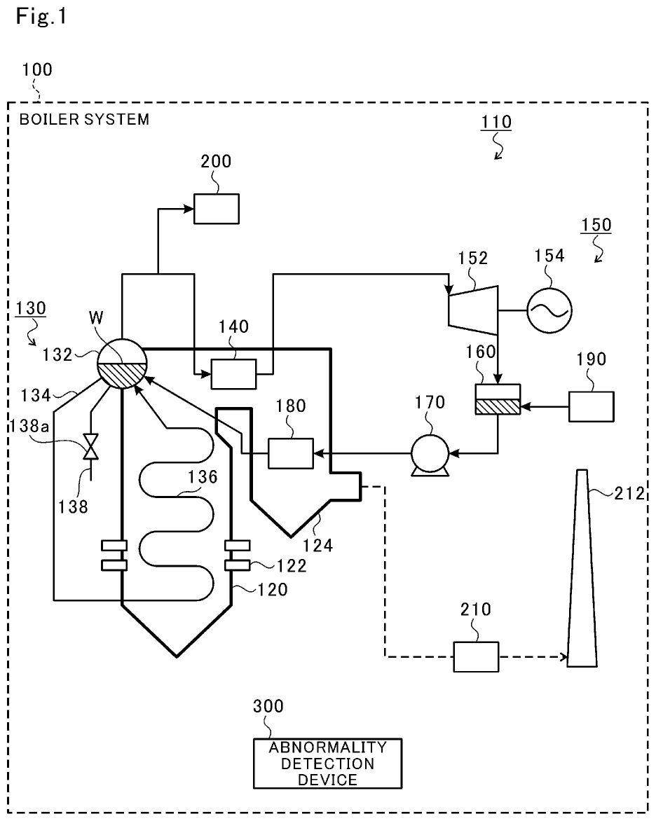

FIG. 1 is a diagram for illustrating a boiler system 100 according to this embodiment. In FIG. 1, each of the solid line arrows indicates a flow of water, and the broken line arrow indicates a flow of a combustion exhaust gas. Further, in this embodiment, liquid water and gaseous water (steam) are sometimes collectively referred to as “water”. As illustrated in FIG. 1, the boiler system 100 includes a boiler 110 and an abnormality detection device 300.

### Boiler 110

The boiler 110 includes a furnace 120, an evaporator 130, a superheater 140, a turbine generator 150, a condenser 160, a feed water pump 170, an economizer 180, a makeup-water supply unit 190, an auxiliary-steam extraction unit 200, and a flue gas treatment system 210.

Burners 122 are provided on side walls of the furnace 120. Fuel such as coal, biomass, or heavy oil and air are supplied to the burners 122. The burners 122 combust the fuel.

A combustion exhaust gas generated as a result of combustion of the fuel by the burners 122 is guided to the flue gas treatment system 210 through a flue gas duct 124 connected to the furnace 120.

The evaporator 130 includes a drum 132, a downcomer 134, a water wall tube 136, and a drain pipe 138. The drum 132 is provided above the furnace 120. The drum 132 stores liquid water and steam. The downcomer 134 connects a lower part of the drum 132 and the water wall tube 136 to each other. The water wall tube 136 is provided in the furnace 120. The water wall tube 136 connects the downcomer 134 and the lower part of the drum 132 to each other.

The drain pipe 138 is connected to the lower part of the drum 132. An on-off valve 138a is provided in the drain pipe 138. The drain pipe 138 is provided so as to allow disposal of the liquid water in the drum 132 to an outside.

The downcomer 134, the water wall tube 136, and the drain pipe 138 are connected to a part of the drum 132, which is located under a waterline W.

The superheater 140 is provided in the furnace 120. The superheater 140 is a heat exchanger that allows the steam guided from the drum 132 and the combustion exhaust gas to exchange heat. The superheater 140 is connected to the drum 132 and the turbine generator 150.

The turbine generator 150 includes a turbine 152 and a power generator 154. The turbine 152 converts thermal energy of the steam guided from the superheater 140 into rotational power. The power generator 154 is connected to the turbine 152 so as to be coaxial therewith. The power generator 154 generates power from the rotational power generated by the turbine 152.

The condenser 160 cools the steam that has passed through the turbine generator 150 to turn the steam into liquid water.

The feed water pump 170 has a suction side that is connected to a lower part of the condenser 160 and a discharge side that is connected to the economizer 180. The feed water pump 170 guides the liquid water condensed in the condenser 160 to the economizer 180.

The economizer 180 is provided in the flue gas duct 124. The economizer 180 is a heat exchanger that allows the liquid water and the combustion exhaust gas to exchange heat.

The makeup-water supply unit 190 supplies liquid water to the condenser 160. The makeup-water supply unit 190 supplies liquid water so that an amount of water circulating through a circulation system described later is maintained at a predetermined value.

The auxiliary-steam extraction unit 200 extracts steam from the drum 132 and supplies the steam to a consumer. The auxiliary-steam extraction unit 200 is, for example, a soot blower.

The flue gas treatment system 210 purifies the combustion exhaust gas. The flue gas treatment system 210 includes, for example, a denitration device, a dust removal device, and a desulfurization device. The combustion exhaust gas that has been purified by the flue gas treatment system 210 is exhausted to the outside through a chimney 212.

Now, a flow of the combustion exhaust gas and a flow of water are described. In FIG. 1, as indicated by the broken line arrow, the combustion exhaust gas generated in the burners 122 first passes through the water wall tube 136 and then passes through the superheater 140. Then, after passing through the economizer 180, the combustion exhaust gas is guided to the flue gas treatment system 210.

Meanwhile, the liquid water generated in the condenser 160 passes through the feed water pump 170 and the economizer 180 in the stated order and is guided to the drum 132. Further, the liquid water in the drum 132 circulates through the downcomer 134 and the water wall tube 136 to thereby evaporate.

Then, the steam in the drum 132 passes through the superheater 140 and is guided to the turbine 152. Further, the steam that has passed through the turbine 152 is returned to the condenser 160.

As described above, water circulates through the condenser 160, the feed water pump 170, the economizer 180, the evaporator 130, the superheater 140, and the turbine 152 in the stated order. Specifically, the boiler 110 has a water circulation system including the condenser 160, the feed water pump 170, the economizer 180, the evaporator 130, the superheater 140, and the turbine 152.

The above-mentioned devices of the circulation system, pipes, the valve, connecting portions between the pipes, connecting portions between the pipe and the valve, and other portions may break due to, for example, aging deterioration in some cases. In those cases, water may leak to the outside through a broken portion.

To deal with the leak, the boiler system 100 according to this embodiment includes the abnormality detection device 300 that detects a water leak. Now, the abnormality detection device 300 is described.

### Abnormality Detection Device 300

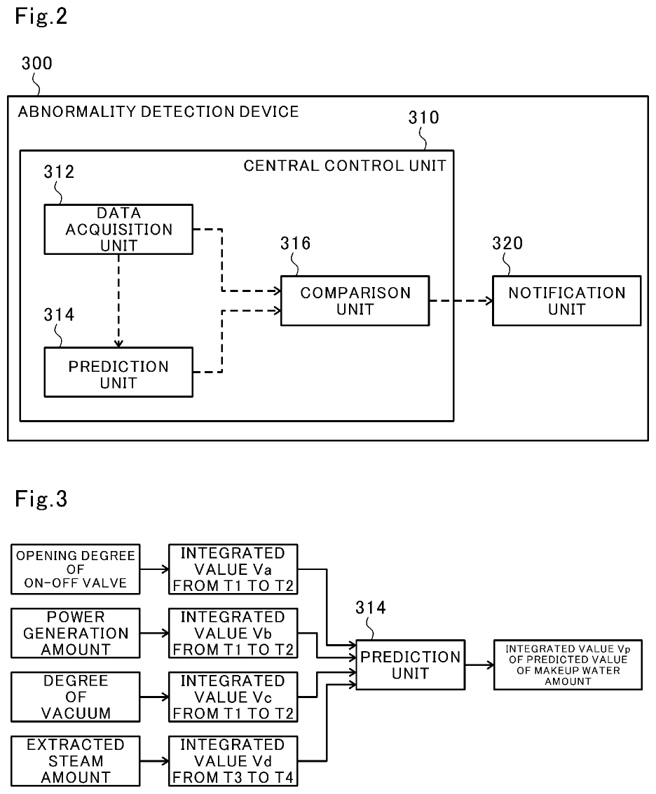

FIG. 2 is a diagram for illustrating the abnormality detection device 300. In FIG. 2, each of the broken line arrows indicates a flow of a signal.

As illustrated in FIG. 2, the abnormality detection device 300 includes a central control unit 310 and a notification unit 320.

The central control unit 310 has a semiconductor integrated circuit including a central processing unit (CPU). The central control unit 310 reads out, for example, a program and a parameter each for operating the CPU from a ROM. The central control unit 310 manages and controls the entire abnormality detection device 300 in cooperation with a RAM serving as a working area and another electronic circuit.

The notification unit 320 includes a display device or a speaker.

In this embodiment, the central control unit 310 functions as a data acquisition unit 312, a prediction unit 314, and a comparison unit 316.

The data acquisition unit 312 acquires operation data of each of a plurality of extraction devices that extract water from the water circulation system of the boiler 110 to an outside of the circulation system. A makeup water amount varies (increases or decreases) depending on operating states of the extraction devices. The extraction devices are, for example, the on-off valve 138a, the turbine generator 150, the condenser 160, and the auxiliary-steam extraction unit 200.

The data acquisition unit 312 acquires, for example, an opening degree of the on-off valve 138a as operation data of the on-off valve 138a. The data acquisition unit 312 acquires, for example, a power generation amount generated by the turbine generator 150 as operation data of the turbine generator 150. The data acquisition unit 312 acquires, for example, a degree of vacuum of the condenser 160 as operation data of the condenser 160. The data acquisition unit 312 acquires, for example, a steam amount extracted by the auxiliary-steam extraction unit 200 as operation data of the auxiliary-steam extraction unit 200.

Further, the data acquisition unit 312 acquires an actually measured value of the makeup water amount that is supplied to the circulation system by the makeup-water supply unit 190.

The prediction unit 314 derives a predicted value of the makeup water amount based on the plurality of pieces of operation data acquired by the data acquisition unit 312.

The prediction unit 314 is constructed through machine learning so as to output the predicted value of the makeup water amount based on the plurality of pieces of operation data acquired by the data acquisition unit 312 and the actually measured value of the makeup water amount while the boiler 110 is operating normally. The machine learning is, for example, XG boost or multiple regression analysis. The normal operation refers to an operating state in which no water leak occurs in the boiler 110.

FIG. 3 is a diagram for illustrating construction of the prediction unit 314. As illustrated in FIG. 3, in this embodiment, the prediction unit 314 is constructed based on an integrated value Va of the opening degree of the on-off valve 138a in a period from a time T1 to a time T2, an integrated value Vb of the power generation amount in the period from the time T1 to the time T2, an integrated value Vc of the degree of vacuum in the period from the time T1 to the time T2, an integrated value Vd of an extracted steam amount in a period from a time T3 to a time T4, and an integrated value of the makeup water amount (actually measured value) in the period from the time T1 to the time T2. The time T4 comes after the time T1 to the time T3. The time T3 comes after the time T1, and the time T2 comes after the time T1. The time T3 may come before or after the time T2 or may be the same as the time T2.

Specifically, an integration period for deriving the integrated value Vd of the extracted steam amount comes after an integration period for integrating the integrated value Va of the opening degree, the integrated value Vb of the power generation amount, the integrated value Vc of the degree of vacuum, and the integrated value of the makeup water amount (actually measured value).

The period from the time T1 to the time T2 is substantially equal to the period from the time T3 to the time T4 and is, for example, one hour.

In the above-mentioned manner, the prediction unit 314 is constructed. The prediction unit 314 uses, as input values, the plurality of pieces of operation data (integrated values) acquired by the data acquisition unit 312, and outputs the predicted value Vp (integrated value) of the makeup water amount as an output value.

The description continues referring to FIG. 2 again. When the predicted value Vp (integrated value) of the makeup water amount is derived by using the thus constructed prediction unit 314, the integrated value Va of the opening degree of the on-off valve 138a in a first predetermined period, the integrated value Vb of the power generation amount in the first predetermined period, the integrated value Vc of the degree of vacuum in the first predetermined period, and the integrated value Vd of the extracted steam amount in a second predetermined period are input to the prediction unit 314. The first predetermined period has a length substantially equal to that of the period from the time T1 to the time T2. The second predetermined period has a length substantially equal to that of the period from the time T3 to the time T4. Further, an end time of the second predetermined period comes after an end time of the first predetermined period.

Then, the prediction unit 314 derives the predicted value Vp (integrated value) of the makeup water amount based on the integrated value Va of the opening degree, the integrated value Vb of the power generation amount, the integrated value Vc of the degree of vacuum, and the integrated value Vd of the extracted steam amount, which are input thereto. For example, as the integrated value Va of the opening degree increases, the predicted value Vp of the makeup water amount, which is derived by the prediction unit 314, increases. Further, as the integrated value Vb of the power generation amount increases, the predicted value Vp of the makeup water amount, which is derived by the prediction unit 314, increases. Further, as the integrated value Vc of the degree of vacuum (pressure) decreases, the predicted value Vp of the makeup water amount, which is derived by the prediction unit 314, increases. Further, as the integrated value Vd of the extracted steam amount increases, the predicted value Vp of the makeup water amount, which is derived by the prediction unit 314, increases.

The comparison unit 316 compares the actually measured value (integrated value in the first predetermined period) of the makeup water amount, which is acquired by the data acquisition unit 312, and the predicted value Vp (integrated value) of the makeup water amount, which is derived by the prediction unit 314, with each other.

Then, when a difference between the actually measured value and the predicted value Vp is equal to or larger than a predetermined threshold value, the comparison unit 316 determines that a water leak has occurred. The threshold value is set to a value that allows the determination of occurrence of a leak.

When it is determined that the leak has occurred, the comparison unit 316 causes the notification unit 320 to output a notification indicating the occurrence of a leak.

### Abnormality Detection Method

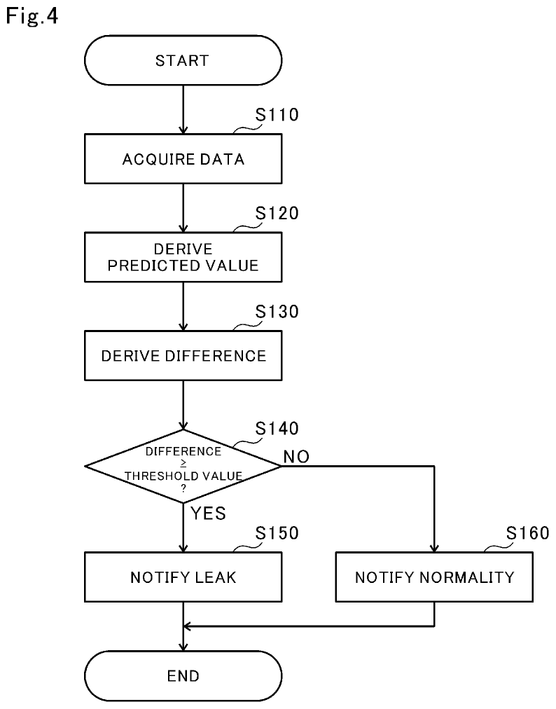

Subsequently, an abnormality detection method using the abnormality detection device 300 is described. FIG. 4 is a flowchart for illustrating a flow of processing of the abnormality detection method according to this embodiment. As illustrated in FIG. 4, the abnormality detection method includes a data acquisition step S110, a predicted-value deriving step S120, a comparison step S130, a determination step S140, a leak notification step S150, and a normality notification step S160. Now, the steps are described.

### Data Acquisition Step S110

In the data acquisition step S110, the data acquisition unit 312 acquires the pieces of operation data of the plurality of extraction devices and the actually measured value of the makeup water amount supplied by the makeup-water supply unit 190.

### Predicted-Value Deriving Step S120

In the predicted-value deriving step S120, the prediction unit 314 derives the predicted value Vp of the makeup water amount based on the plurality of pieces of operation data acquired in the above-mentioned data acquisition step S110. As described above, the prediction unit 314 is constructed in advance through machine learning so as to output the predicted value Vp of the makeup water amount based on the pieces of operation data of the plurality of extraction devices.

### Comparison Step S130

In the comparison step S130, the comparison unit 316 compares the actually measured value of the makeup water amount, which has been acquired in the data acquisition step S110, and the predicted value Vp of the makeup water amount, which has been derived in the predicted-value deriving step S120, with each other. In this embodiment, the comparison unit 316 derives a difference between the actually measured value and the predicted value Vp.

### Determination Step S140

The comparison unit 316 determines whether or not the difference derived in the comparison step S130 is equal to or larger than a predetermined threshold value. As a result, when it is determined that the difference is equal to or larger than the threshold value (YES in Step S140), the processing performed by the comparison unit 316 proceeds to the leak notification step S150. Meanwhile, when it is determined that the difference is smaller than the threshold value (NO in Step S140), the processing performed by the comparison unit 316 proceeds to the normality notification step S160.

### Leak Notification Step S150

The comparison unit 316 causes the notification unit 320 to output a notification that a water leak has occurred.

### Normality Notification Step S160

The comparison unit 316 causes the notification unit 320 to output a notification that a water leak has not occurred, specifically, the boiler is normal.

As described above, the abnormality detection device 300 and the abnormality detection method according to this embodiment derive the predicted value Vp of the makeup water amount by using the prediction unit 314 that is constructed through learning of only the pieces of operation data of the plurality of extraction devices during a normal operation. As a result, the prediction unit 314 can exclude a leak (extraction of water from the circulation system due to a factor other than the extraction by the extraction devices) and derive the predicted value Vp of the makeup water amount, which corresponds only to the amount of water extracted by the extraction devices. Thus, the comparison unit 316 can detect a water leak by comparing the predicted value Vp of the makeup water amount and the actually measured value of the makeup water amount with each other. Accordingly, the abnormality detection device 300 can accurately detect a water leak in the boiler 110.

Further, as described above, the prediction unit 314 is constructed so as to derive the predicted value Vp of the makeup water amount based on the integrated values of the pieces of operation data of the extraction devices in the predetermined periods. Further, when the prediction unit 314 detects a leak, the prediction unit 314 derives the predicted value Vp of the makeup water amount based on the integrated values of the pieces of operation data of the extraction devices in the predetermined periods. As a result, prediction accuracy of the prediction unit 314 can be improved.

Further, as described above, the integration period for deriving the integrated value Vd of the extracted steam amount, which is used when the prediction unit 314 is constructed and when the prediction unit 314 is used, is shifted so as to come after the integration period for deriving the integrated value Va of the opening degree of the on-off valve 138a, the integrated value Vb of the power generation amount, and the integrated value Vc of the degree of vacuum. A predetermined period is required from the end of extraction (consumption) of steam by the auxiliary-steam extraction unit 200 until the makeup water for losses is supplied by the makeup-water supply unit 190. Thus, the integration period for deriving the integrated value Vd of the extracted steam amount is shifted so as to come after the integration period for deriving the other integrated values. As a result, the predicted value Vp of the makeup water amount can be derived with high accuracy.

### EXAMPLE

A leak detection (example) using the above-mentioned abnormality detection device 300 and a leak detection (comparative example) carried out by a supervisor were conducted in the boiler 110.

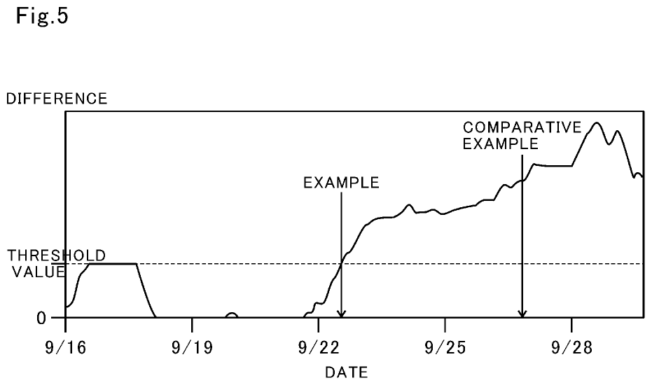

FIG. 5 is a graph for showing a time-dependent change in difference between the actually measured value and the predicted value Vp, which are derived by the abnormality detection device 300. In FIG. 5, a vertical axis represents a difference between the actually measured value and the predicted value Vp, and a horizontal axis represents a date.

As shown in FIG. 5, from around September 16 to around September 18, the difference derived by the abnormality detection device 300 was nearly the threshold value. It is considered that this is because the auxiliary-steam extraction unit 200 supplied a large amount of auxiliary steam to activate another boiler 110. Further, the difference derived by the abnormality detection device 300 started increasing around September 22. Then, the abnormality detection device 300 detected a leak on September 22. Meanwhile, the supervisor detected the leak on September 27.

From the above-mentioned result, it was confirmed that the abnormality detection device 300 was able to detect a leak five days earlier than a related-art technology with a supervisor.

The embodiment has been described above with reference to the attached drawings, but, needless to say, the present disclosure is not limited to the above-mentioned embodiment. It is apparent that those skilled in the art may arrive at various alternations and modifications within the scope of claims, and those examples are construed as naturally falling within the technical scope of the present disclosure.

For example, in the embodiment described above, there has been exemplified a case in which the prediction unit 314 derives the predicted value of the makeup water amount based on the integrated values of the pieces of operation data of the extraction devices in the predetermined periods. However, the prediction unit 314 is only required to derive the predicted value of the makeup water amount by performing predetermined statistical processing on the pieces of operation data of the extraction devices. The statistical processing includes not only processing of deriving the integrated values of the pieces of operation data of the extraction devices in the above-mentioned predetermined periods but also, for example, processing of deriving an average value (including weighted average or moving average) of the operation data in a predetermined period or a variation (variance or standard deviation) in the operation data in a predetermined period. In this manner, the prediction accuracy of the prediction unit 314 can be improved.

Further, in the embodiment described above, there has been exemplified a case in which the integrated value Vd of the extracted steam amount is acquired in the period (integration period) that is different from the period in which the other integrated values are acquired. However, independently of the extracted steam amount, at least one of the plurality of pieces of operation data used in the prediction unit 314 may be acquired at a timing or in a period, which is different from a timing or a period at or in which the other pieces of operation data are acquired.

Further, in the embodiment described above, the on-off valve 138a, the turbine generator 150, the condenser 160, and the auxiliary-steam extraction unit 200 have been described as examples of the extraction devices. However, the extraction devices may be other devices as long as the makeup water amount varies (increases or decreases) depending on the operating states of the extraction devices.

Further, in the embodiment described above, there has been exemplified a case in which the data acquisition unit 312 acquires the pieces of operation data of all of the on-off valve 138a, the turbine generator 150, the condenser 160, and the auxiliary-steam extraction unit 200. However, the data acquisition unit 312 may acquire the operation data of one or two or more of the on-off valve 138a, the turbine generator 150, the condenser 160, and the auxiliary-steam extraction unit 200. In this case, the prediction unit 314 is constructed so as to output the predicted value of the makeup water amount based on the operation data acquired by the data acquisition unit 312. Further, in this case, it is preferred that the extraction device that extracts a relatively large amount of water be selected.

Further, in the embodiment described above, there has been exemplified a case in which the period from the time T1 to the time T2, the period from the time T3 to the time T4, the first predetermined period, and the second predetermined period are substantially equal. However, any one or a plurality of periods among the period from the time T1 to the time T2, the period from the time T3 to the time T4, the first predetermined period, and the second predetermined period may have a length different from those of the other periods.

Still further, in the embodiment described above, there has been exemplified a case in which the abnormality detection device 300 constantly determines whether or not a water leak has occurred. However, the abnormality detection device 300 may exclude a period in which data is difficult to acquire, such as a period before and after the activation of the boiler 110 or a period in which the boiler 110 is intentionally stopped, or a period in which disturbance occurs, from the period in which it is determined whether or not a water leak has occurred.

The steps of the abnormality detection method described in this specification are not always required to be conducted in time series in accordance with the order described in the flowchart, but may be conducted in parallel or include sub-routine processing.

A program for causing a computer to function as the abnormality detection device 300 or a recording medium that stores the program is also provided. The recording medium includes a computer readable flexible disk, a magneto-optical disk, a ROM, an EPROM, an EEPROM, a compact disc (CD), a digital versatile disc (DVD), and a Blu-ray (trademark) disc (BD). In this case, the program corresponds to data processing means described in a suitable language or by a suitable description method.

What is claimed is:

1. An abnormality detection device, comprising:
a data acquisition unit configured to acquire operation data of one or a plurality of extraction devices configured to extract water from a water circulation system in a boiler to an outside of the circulation system, and acquire an actually measured value of a makeup water amount supplied to the circulation system;
a prediction unit configured to derive a predicted value of the makeup water amount based on the operation data acquired by the data acquisition unit; and
a comparison unit configured to compare the actually measured value of the makeup water amount, which is acquired by the data acquisition unit, and the predicted value of the makeup water amount, which is derived by the prediction unit, with each other.

2. The abnormality detection device according to claim 1, wherein the prediction unit is configured to derive the predicted value of the makeup water amount by performing predetermined statistical processing on the operation data.

3. The abnormality detection device according to claim 2, wherein the statistical processing is processing of deriving an integrated value, an average value, or a variance of the operation data of the extraction device in a predetermined period.

4. The abnormality detection device according to claim 1, wherein at least one of the plurality of pieces of operation data used in the prediction unit is acquired at a timing or in a period different from a timing or a period at or in which the other piece of operation data is acquired.

5. An abnormality detection method, comprising:
a step of acquiring operation data of one or a plurality of extraction devices configured to extract water from a water circulation system in a boiler to an outside of the circulation system, and acquiring an actually measured value of a makeup water amount supplied to the circulation system;
a step of deriving a predicted value of the makeup water amount based on a plurality of acquired pieces of the operation data; and
a step of comparing the acquired actually measured value of the makeup water amount and the derived predicted value of the makeup water amount with each other.
